(19) United States
(12) Patent Application Publication
(10) Pub. No.: US 2006/0190322 A1
(43) Pub. Date: Aug. 24, 2006

(54) Method and system for managing an incentive fund

(76) Inventors: Mark Charles Oehlerking, Waukee, IA (US); Greg Alan Unruh, Clive, IA (US); Greg William Hoover, Johnston, IA (US); Timothy Wayne Boehle, Belvidere, IL (US)

Correspondence Address: DEERE & COMPANY, ONE JOHN DEERE PLACE, MOLINE, IL, 61265, US

(21) Appl. No.: 11/062,503

(22) Filed: Feb. 22, 2005

(51) Int. Cl. G06Q 30/00; G06Q 40/00

(52) U.S. Cl. 705/14; 705/39

(57) ABSTRACT

A sponsor or another establishes a pool of incentive funds to be used by designated merchants to fund sponsored incentive programs for at least one of a sale and a lease of a product. An amount of each incentive fund is allocated for a designated merchant. One or more credit plans are designated, where each credit plan is associated with or eligible for each incentive fund. The discretionary distribution of each incentive fund is supported. For example, each incentive fund may be distributed to one or more selected customers based on a customer loyalty program or other parameters.

### FIELD OF THE INVENTION

The invention relates to a method and system for managing an incentive fund for promoting a transaction associated with one or more products.

### BACKGROUND OF THE INVENTION

Sponsors of credit plans may provide incentive funds to merchants to promote transactions (e.g., sales or lease) of one or more products. There is a need for the sponsor to budget and manage its financial exposure to credit plan programs and promotions.

### SUMMARY OF THE INVENTION

In accordance with one aspect of the invention, a sponsor or another establishes a pool of incentive funds to be used by one or more designated merchants to fund one or more incentive programs for a transaction (e.g., a sale or lease) related to a product. An amount of each incentive fund within the pool is allocated for a respective designated merchant. One or more eligible credit plans are designated, that are eligible for use in conjunction with a corresponding incentive fund. The discretionary distribution of each incentive fund is supported. For example, the designated merchant may distribute the incentive fund to one or more selected customers based on a customer loyalty program or other customer parameters, consistent with one of the eligible credit plans.

### BRIEF DESCRIPTION OF THE DRAWINGS

FIG. 1 is a block diagram of one embodiment of a system for managing a fund in accordance with the invention.

FIG. 2 is a flow chart of a first embodiment of a method for managing a fund.

FIG. 3 is a flow chart of a second embodiment of a method for managing a fund.

FIG. 4 is a flow chart of a third embodiment of a method for managing a fund.

FIG. 5 is a flow chart of a fourth embodiment of a method for managing a fund.

FIG. 6 is an illustrative example of a flow chart that shows how funds are distributed from a sponsor to customers.

FIG. 7 is a block diagram of another embodiment of a system for managing a fund in accordance with the invention.

### DESCRIPTION OF THE PREFERRED EMBODIMENT

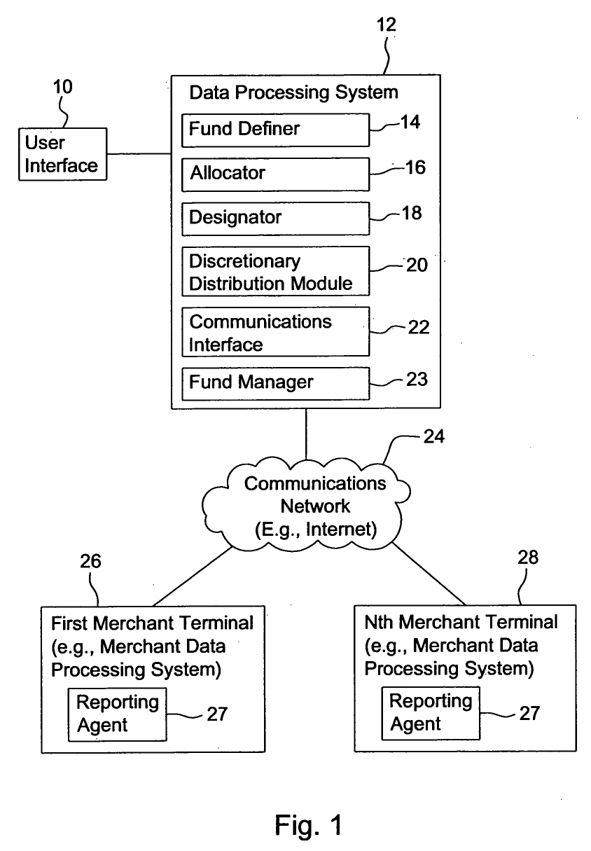

In accordance with one embodiment, which is shown in FIG. 1, a system for managing a fund comprises a data processing system 12 associated with a user interface 10. The data processing system 12 communicates to one or more merchant terminals (26, 28) via a communications network 24 (e.g., the Internet). In one embodiment, the merchant terminals may include a first merchant terminal 26 through an Nth merchant terminal 28, where N equals any whole number greater than two. Each merchant terminal (26, 28) has a reporting agent 27.

The user interface 10 may comprise a display (e.g., a touch screen or touch sensitive display), keyboard, a keypad, a pointing device (e.g., a mouse or trackball), a disc drive, an optical drive, a magnetic drive, a tape drive, or any combination of the foregoing items. A user (e.g., a sponsor) may enter or input data into the data processing system 12 via the user interface 10.

In the embodiment of FIG. 1, the data processing system 12 comprises a fund definer 14, an allocator 16, a designator 18, a discretionary distribution module 20, a communications interface 22, and a fund manager 23. The fund definer 14 defines a fund, an incentive fund, or a pool of incentive funds. For example, a user (e.g., sponsor) may enter or input fund parameters via the user interface 10 to establish an individual incentive fund or a pool of incentive funds. The fund may comprise a pool of incentive funds to be used by designated merchants (e.g., qualified merchants) for transactions (e.g., sales or leases) of products or product lines. For example, the incentive fund may comprise a sales finance fund that refers to a budget amount established by sponsor for a merchant to use for the cost (or certain percentage of the cost) of marketing or promoting one or more credit or financial plans associated with products.

The allocator 16 provides a framework for determining an allocation of the incentive fund among one or more merchants. The allocator 16 may comprise a budgeting or forecasting tool. The sponsor may use the allocator 16 to allocate a particular amount of funds for any of the following: (1) a particular merchant, (2) a particular product, (3) a particular product line, (4) a particular region, country or territory, (5) a particular credit plan, and (6) a particular set of customers. In one embodiment, the allocator 16 may be used to increase or decrease the amount allotted (in the incentive fund) to a particular corresponding merchant.

The designator 18 may represent a filter or selector of credit plans that are suitable for the allocated incentive funds or fund. The sponsor may determine which credit plans are eligible or suitable for an incentive fund. In an alternate embodiment, all available credit plans may be eligible or suitable for an incentive fund, unless the sponsor determines otherwise.

The discretionary distribution tool 129 facilitates a merchant's discretionary distribution of the fund, or a portion thereof, to one or more customers of the merchant. The sponsor may place limits on the merchant's discretionary distribution of the funds through the fund manager 23, the discretionary distribution module 20, or both.

The fund manager 23 facilitates establishing rules for the management of the pool of funds. In one example, the fund manager 23 may establish rules for the merchants who receive the funds. In another example, the fund manager 23 may establish a warning where the merchant reaches a threshold.

The communications interface 22 supports communications between the data processing system 12 and one or more merchant terminals. Each merchant terminal may comprise a reporting agent 27.

The reporting agent 27 reports reporting data (e.g., fund management data) to the data processing system 12 or fund manager 23 via the communications network 24.

The data processing system 12 may be owned, leased or controlled by the sponsor or made available (e.g., as a service or service bureau) to the sponsor. The sponsor may comprise (1) a manufacturer, supplier, distributor, wholesaler, dealer, or another business entity that markets, offers, uses, sells, or makes a product, or (2) a federal bank, a state bank, a lender, a lending institution, a credit union, a savings and loan, a thrift, or another financial institution that offers, supports, or participates in one or more credit plans for a transaction (e.g., sales or lease) in a product. The sponsor of the system for managing a fund may charge or bill the merchant on a regular basis (e.g., monthly) or otherwise for the cost of any allocated funds (e.g., incentives) actually used from the incentive fund. For example, the fund manager 23 may facilitate the preparation and/or transmission of electronic invoices, electronic statements, paper invoices or paper statements, or other billing or transactional documentation. The data processing system 12 supports the sponsor's management of its total exposure to credit plan costs by allocating an aggregate fund amount, merchant-specific amounts, or both, while giving the merchant enhanced flexibility to offer-or-distribute funds among one or-more customers based on local knowledge, familiarity with the customer, customer loyalty data, historical customer data, point-of-sale information, or other customer parameters. Accordingly, the merchant can tailor the distribution in accordance with its resources, its customer parameters, and its preferences to best interact with the local marketplace.

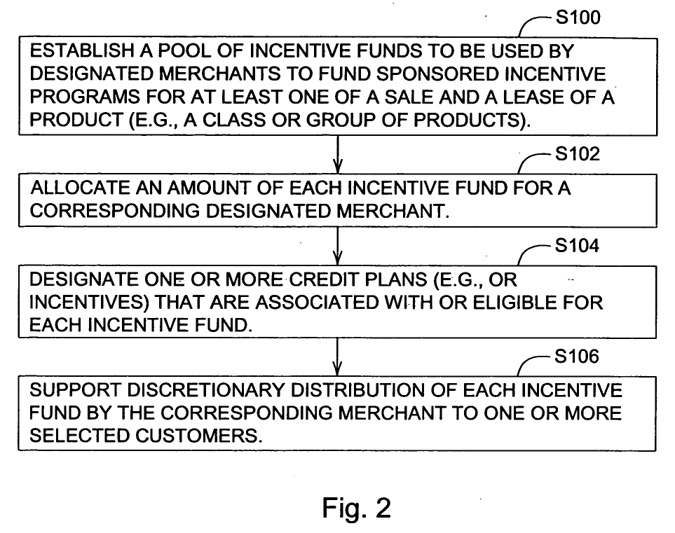

FIG. 2 is a method for managing a fund. The method of FIG. 2 begins in step S100.

In step S100, a fund definer 14 or data processing system 12 establishes a pool of incentive funds to be used by designated merchants (e.g., qualified merchants) to fund one or more sponsored incentive programs for a transaction (e.g., sale or a lease) associated with a product (e.g., a class or group of products). An incentive program can be integrated into the credit plan or separate from the credit plan. An example of integration of the incentive program into the incentive plan is deferred interest or promotional interest rate for a corresponding credit plan. In contrast, an incentive program such as a rebate or discount on a product may be separate from the credit plan.

In one procedure for carrying out step S100, the sponsor or another creates a list of qualified merchants. A list of potential merchants may be collected where merchants register, display an indication of interest, or complete an application for participation (e.g., via a merchant terminal over the communications network 24 or otherwise). The data processing system 12 or fund definer 14 screens the potential merchants to identify qualified merchants. The data processing system 12 of fund definer 14 may establish a list of qualified merchants based on a merchant rating criteria. The merchant rating criteria may comprise any of the following: financial qualifications of the merchants, financial statements of the merchants, historical business dealings (e.g., of the sponsor with the merchant), historical financial performance of the merchant, sales volume, creditworthiness, credit rating, (e.g., Standard and Poor's credit rating of the merchant), debt rating, bankruptcy filing, featured products, product lines, product parameters, historic merchant transactions, historic merchant transaction (e.g., sales) volume, merchant parameters, credit programs, customer-parameters associated with the merchant, customer demographics associated with the merchant, seasonal constraints, and geographic constraints. The selected or qualified merchants may be assigned merchant identifiers to distinguish merchants from each other.

Although step S100 may be applied to commerce in virtually any product, in one illustrative example, the product comprises an agricultural input selected from the group consisting of seed, fertilizer, herbicide, insecticide, pesticide, fungicide, plant stock, root stock, nutrients, and chemicals. In another example, the product comprises one or more of the following: agricultural equipment, construction equipment, turf-care equipment, mowing equipment, forestry equipment, and power generation equipment.

In the pool of incentive funds, one merchant may be assigned one or more funds, where each fund corresponds to a different product line of products. For example, a merchant may be assigned to a first fund associated with first allocated amount and a first product (e.g., seeds) or first product line and the merchant may be assigned a second fund associated with a second allocated amount and a second product (e.g., chemicals or herbicides) or second product line.

In step S102, a fund allocator 16 or data processing system 12 allocates an amount of each incentive fund for a corresponding designated merchant, a total amount for the pool of incentive funds for multiple designated merchants, or both. The amount of each incentive fund or the pool of incentive funds may be determined based on available resources of the sponsor, merchant rating criteria, and market information on a customer's business.

In step S104, a designator 18 or data processing system 12 designates one or more credit plans that are associated with or eligible for each incentive fund. A credit plan refers to a plan, contract, note, financing, or another financial arrangement that provides credit, a loan, a lease, a rebate, deferred interest payment plan, installment contract, a credit line or loan with no money down, promotional interest rate, a credit line or loan with reduced interest rate, a credit line or loan with a deferred interest payment, or another incentive to a customer or potential customer of a merchant. An eligible credit plan refers to a particular credit plan that the sponsor has approved for one or more of the following: a customer or group of customers, a merchant or group of merchant, a product or group of products, a transaction type or group of transaction types (e.g., loan, lease, revolving credit).

In one embodiment, each credit plan is associated with credit plan eligibility guidelines or rules established by the merchant rules, by the sponsor, or both for eligibility of customers with respect to the credit plan. The credit plan may further include credit plan compliance rules for compliance by the merchant with the credit plan. The credit plan eligibility rules may comprise minimum transaction amount, start date, end data, availability period, suggested customers to target, eligible products and services, and any costs to be borne by the merchant.

In step S106, a discretionary distribution module 20 or data processing system 12 supports discretionary distribution of each incentive fund by the corresponding merchant to one or more selected customers. The support of discretionary distribution may be executed in accordance with various techniques, that may be applied alternately and cumulatively. Under a first technique, the discretionary distribution module 20 allows the merchant to determine an amount of each incentive fund to be available for incentive programs to individual customers at the point of sale based on at least one of the preferences of the merchant (e.g., objective customer screening data based on past financial performance of a customer) and a customer loyalty program. Under a second technique, the discretionary distribution module 20 allows the merchant to determine an amount of each incentive fund to be available for incentive programs for individual customers based on the preferences of the merchant and a customer loyalty program. Under a third technique, the discretionary distribution module 20 allows the merchant to determine an amount of each incentive fund to be available for incentive programs for individual customers based on customer screening data. Customer screening data means at least one of historical transactions of individual customers, a credit rating of the individual customers, a credit score of the individual customers, and estimated or projected crop prices (e.g., market or contract prices) associated with the crop inputs to be purchased by customers. Under a fourth technique, the discretionary distribution module 20 provides an electronic tool to the merchant for distribution of the funds (e.g., via incentive programs) among individual customers based on customer screening data and a customer loyalty management program. Under a fifth technique, the discretionary distribution module 20 uses the incentive fund to implement one or more promotions or incentive programs to customers. For example, the promotions may comprise low interest rates, extended no-interest periods, deferred first payments for one or more customers that purchase a product or a particular product or participate in a particular incentive plan.

The method and system is well suited for point-of-sale incentives determined at the discretion of a merchant or vendor, or other party at the point of sale. Accordingly, the merchant may have greater financial flexibility to negotiate and close deals with customers based on customer interaction. The merchant can use its resources (e.g., financial analysis, cost accounting sales and marketing) in an informed manner to analyze customer screening data, its remaining allotment or budget of discretionary incentive to best promote transactions in a particular product, product line or group of products or to promote participation in various credit plans.

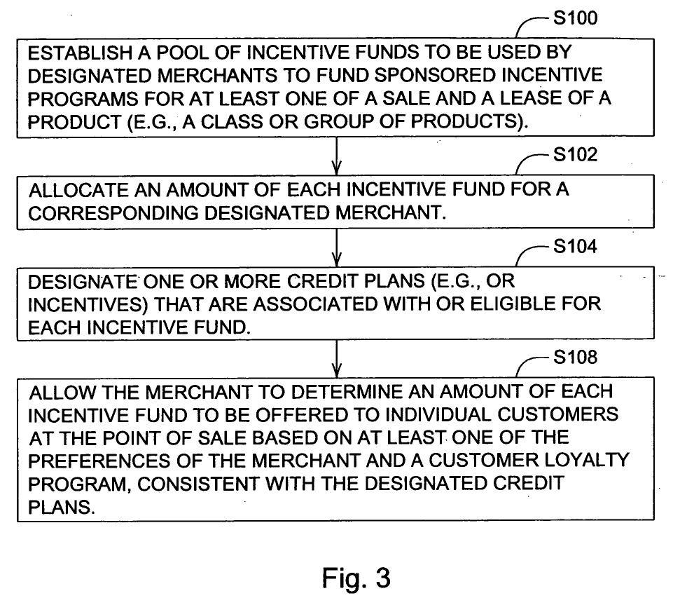

The fund management method of FIG. 3 is similar to the fund management method of FIG. 2, except the fund management method of FIG. 3 replaces step S106 with step S108. Like reference numbers in FIG. 2 and FIG. 3 indicate like procedures or steps.

In step S108, the discretionary distribution module 20 or the data processing system 12 allows the merchant to determine an amount of each incentive fund to be offered to individual customers (via an incentive program) at the point of sale based on merchant preferences, a customer loyalty program, or both, consistent with the designated credit plans. The credit plans were designated to step S104, for example. The incentive program may be applied separate from the credit plan or the incentive program may be integrated into the credit plan. If the incentive program is integrated with the credit plan, the standard terms of the credit plan may be relaxed in accordance with available incentive funds.

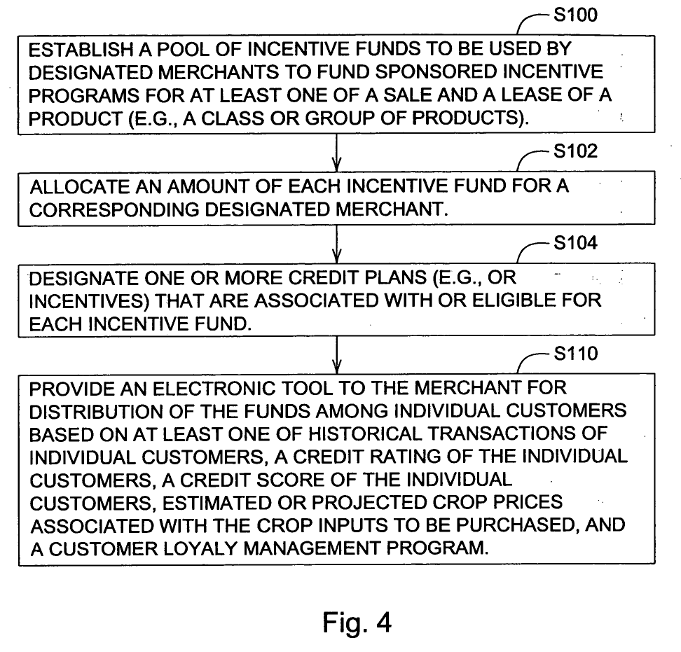

The fund management method of FIG. 4 is similar to the fund management method of FIG. 2, except the fund management method of FIG. 4 replaces step S106 with S110. Like-reference numbers in FIG. 2 and FIG. 4 indicate like procedures or steps.

In step S110, the discretionary distribution module 20 or the data processing system 12 provides a distribution tool (e.g., distribution tool 129 in FIG. 6) to the merchant for distribution of the funds among individual customers based on at least one of the following customer screening criteria: (1) historical transactions of individual customers, (2) a credit rating of the individual customers, (3) a credit score of the individual customers, (4) estimated or projected crop prices associated with the crop inputs to be purchased, (5) a customer loyalty management program, and (6) market prices of crop futures or option contracts (e.g., on the Chicago Board of Trade) for corresponding crop maturity dates. The crop maturity date may be estimated if the seed variety, crop variety and planting date are known. The distribution tool 129 facilitates the provision of structured or disciplined financial analysis to the merchant such that the merchant can readily and conveniently evaluate customers and distribute incentive funds in accordance with prudent risk management techniques and sound financial management principles.

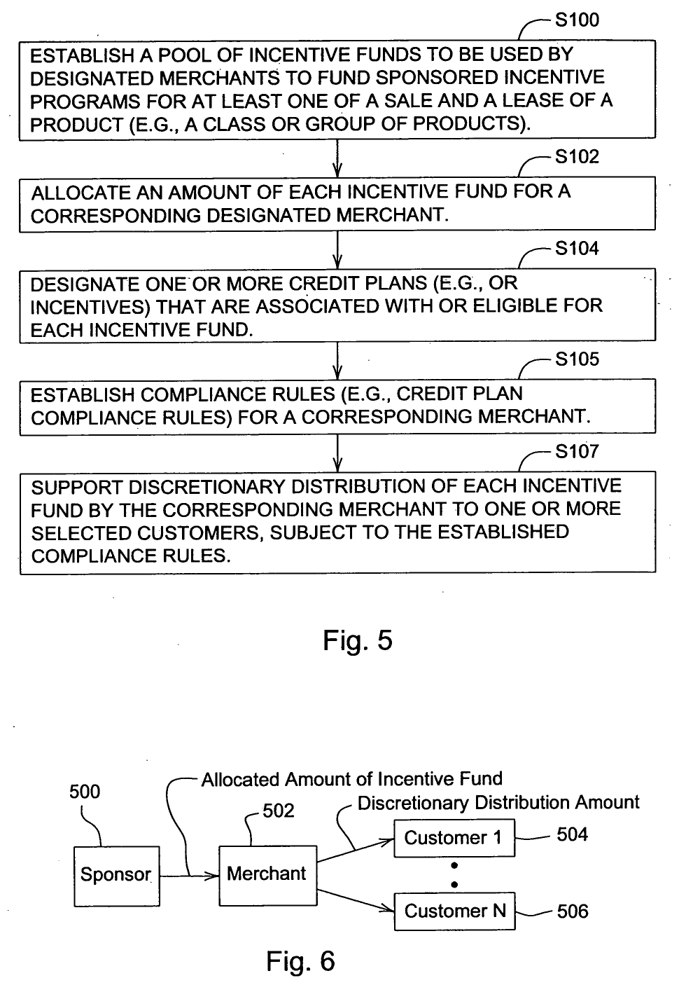

The fund management method of FIG. 5 is similar to the fund management method of FIG. 2, except the fund management method of FIG. 5 replaces step S106 with step S107 and adds new step S105. Like reference numbers in FIG. 2 and FIG. 5 indicate like elements.

In step S105, a data processing system 12 or fund manager 23 supports the establishment of compliance rules for a corresponding merchant. The established compliance rules may comprise one or more of the following: (1) warn or communicate a warning (e.g., data packets, a voice message, a data message, or e-mail via the communications network 24) to merchant if the merchant is close to a limit or the allocated amount of step S102; (2) remove merchant from pool or change merchant status to inactive or suspended if merchant meets or exceeds a limit or the allocated amount of step S102, (3) reallocate funds among existing merchants if merchant violates a rule, exceeds a limit, mergers, dissolves, ceases business operations, enters into a bankruptcy proceeding, or suffers a change of control, (4) revoke eligibility of customer to participate in a credit plan based on customer screening criteria or (5) revoke eligibility of merchant to participate in a credit plan. If the merchant has used up the allocated amount of step S102, the merchant may no longer be eligible to participate in the designated credit plan(s).

In step S107, the data processing system 12 or discretionary distribution module 20 supports discretionary distribution of each incentive fund by the corresponding merchant to one or more selected customers, subject to the established compliance rules.

FIG. 6 shows the flow of funds from the sponsor 500 to one or more customers (504, 506) via a merchant 502. Although one merchant 502 is shown, in practice the sponsor 500 may work with many merchants. The sponsor 500 allocates an amount of the incentive fund (e.g., a portion of a pool of incentive funds) for a corresponding merchant. The allocated amount may be associated with particular products, particular credit plans, or both. The merchant 502 may allocate none, all or some of the incentive fund among one or more customers (504, 506). The allocated amount may be referred to as a discretionary distribution amount. In one example, the sponsor may charge the merchant for the use of the incentive fund, as part of a revolving interest loan. In another example, the sponsor may bear the cost of the incentive fund to promote a transaction in a product or the issuance of credit.

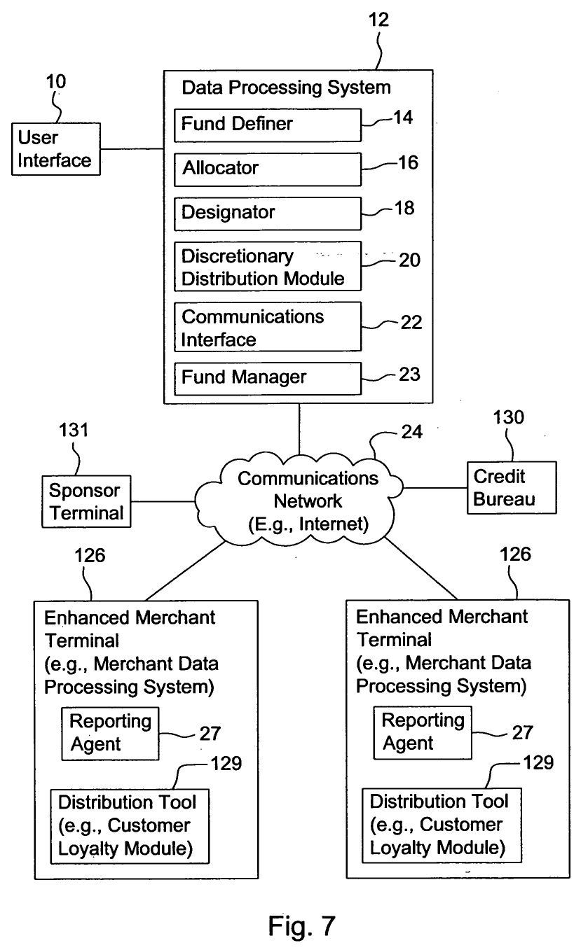

The system of FIG. 7 is similar to the system of FIG. 1 except the system of FIG. 7 further comprises a credit bureau 130 and enhanced merchant terminals 126. Like reference numbers in FIG. 1 and FIG. 7 indicate like elements.

The credit bureau 130 communicates with an enhanced merchant terminal 126. The user or merchant that uses the enhanced merchant terminal 126 may obtain customer screening criteria or access financial data, credit data, or risk data associated with one or more customers. The accessed or collected data is well suited for supporting the discretionary allocation of funds to particular corresponding customers.

In one embodiment, the fund manager 23 may be associated with a billing module for generating a bill or invoice to sponsor based on each merchant's use of the allocated funds. For example, the billing module may generate a bill based on an interest rate, a duration of credit extended to the customer, merchant or another party, and an amount of credit extended. The generated bill is transmitted from the data processing system 12 to the sponsor terminal 131 via the communications network.

The enhanced merchant terminal 126 may further comprise a distribution tool 129 for facilitating the distribution of a discretionary distribution amount to corresponding particular customers. In one embodiment, the distribution tool 129 comprises a customer loyalty module for administering or tracking a customer loyalty program. For example, the customer loyalty module may support giving loyal or repeat customers special discounts and incentives as discretionary distribution amounts to induce a transaction associated with a product (e.g., a crop input).

In one configuration, the distribution tool 129 allows a merchant to select a preferential credit plan for a corresponding customer from among two or more credit plans made eligible by the sponsor or via the data processing system 12. The distribution tool 129 allows the merchant (e.g., via the enhanced merchant terminal 126) to calculate a blended cost of the incentive. The blended cost of the incentive takes into account the sales subject to the sponsored incentive with the incentive cost paid from the incentive fund, less any additional amount paid by the merchant as supplemental incentive and then calculates average cost of sales across all sales of the merchant (for sales that are subsidized by the fund and sales that are not subsidized by the fund for the particular merchant). Further, the distribution tool 129 may allow the merchant to compare use of the incentive program and the incentive fund, to the merchant's own use of cash incentives or cash discounts separate and apart from the allocated fund. If the particular merchant exhausts the amount of funds allocated to the particular merchant, the particular merchant may use its own supplemental incentive or other credit plans. The merchant would ordinarily pay the entire cost of the supplemental incentive, for example.

In one embodiment, the allocator 16 may be used to increase or decrease the amount allotted to a particular corresponding merchant based on data (e.g., fund management data) reported by the reporting agent 126 via the communications network 24. The reporting agent 126 may send a message to the fund manager if the merchant depletes a fund, disburses incentives that exceed a threshold maximum over a certain period of time, or if the merchant reaches a user-definable target for disbursement of incentives to customers or for corresponding credit plans or for an allocated amount of the incentive fund.

In an alternate embodiment, customer terminals may be coupled to the communications network 24 for communication with the enhanced merchant terminal 126. However, where the merchant has a retail office or physical sales location, it may not be necessary to support electronic commerce between the customer terminal (e.g., personal computer) and the enhanced merchant terminal 126.

The system and method for managing a fund is intended to support enhanced sales and maintenance of product margins by managing various combinations of credit plans and sales prices for products financed.

Having described the preferred embodiment, it will become apparent that various modifications can be made without departing from the scope of the invention as defined in the accompanying claims.

The following is claimed:

1. A method for managing a fund, the method comprising:
establishing a pool of incentive funds to be used by designated merchants to fund sponsored incentive programs for at least one of a sale and a lease of a product;
allocating an amount of each incentive fund within the pool for a corresponding designated merchant; and
designating one or more respective credit plans that are associated with or eligible for each incentive fund; and
supporting discretionary distribution of each incentive fund by the corresponding merchant to one or more selected customers.

2. The method according to claim 1 wherein the product comprises an agricultural input selected from the group consisting of seed, fertilizer, herbicide, insecticide, pesticide, fungicide, plant stock, root stock, nutrients, and chemicals.

3. The method according to claim 1 wherein the product comprises one or more of the following: agricultural equipment, construction equipment, turf-care equipment, mowing equipment, forestry equipment, off-road utility vehicles, wind turbines, monopoles, towers, and electrical power generation equipment.

4. The method according to claim 1 wherein the supporting of the discretionary distribution comprises allowing the merchant to determine an amount of each incentive fund to be offered to individual customers at a point of sale based on at least one of the preferences of the merchant and a customer loyalty program.

5. The method according to claim 1 wherein the supporting the discretionary distribution comprises allowing the merchant to determine an amount of each incentive fund to be offered to individual customers based on the preferences of the merchant and a customer loyalty program.

6. The method according to claim 1 wherein the supporting the discretionary distribution comprises allowing the merchant to determine an amount of each incentive fund to be offered to an individual customer based at least one of historical transactions of the individual customer, a credit rating of the individual customer, a credit score of the individual customer, and estimated or projected crop prices associated with the crop inputs to be purchased, and market prices of the crop futures or option contracts for a respective projected crop maturity date.

7. The method according to claim 1 wherein the supporting of the discretionary distribution comprises providing an electronic tool-to the merchant for distribution-of the funds among an individual customer based on at least one of historical transactions of individual customer, a credit rating of the individual customer, a credit score of the individual customer, estimated or projected crop prices associated with the crop inputs to be purchased, market prices of crop futures for the projected crop maturity date, and a customer loyalty management program.

8. A system for managing a fund, the system comprising:
a fund definer for establishing a pool of incentive funds to be used by designated merchants to fund sponsored incentive programs for at least one of a sale and a lease of a product;
an allocator for allocating an amount of each incentive fund within the pool for a corresponding designated merchant; and
a designator for designating one or more respective credit plans that are associated with or eligible for each incentive fund; and
a discretionary distribution module for supporting discretionary distribution of each incentive fund by the corresponding merchant to one or more selected customers.

9. The system according to claim 8 wherein the product comprises an agricultural input selected from the group consisting of seed, fertilizer, herbicide, insecticide, pesticide, fungicide, plant stock, root stock, nutrients, and chemicals.

10. The system according to claim 8 wherein the product comprises one or more of the following: agricultural equipment, construction equipment, turf-care equipment, mowing equipment, forestry equipment, off-road utility vehicles, wind turbines, towers, monopoles, and electrical power generation equipment.

11. The system according to claim 8 wherein the discretionary distribution module allows the merchant to determine an amount of each incentive fund to be offered to individual customers at a point of sale based on at least one of the preferences of the merchant and a customer loyalty program.

12. The system according to claim 8 wherein the discretionary distribution module determines an amount of each incentive fund to be offered to individual customers based on at least one of preferences of the merchant and a customer loyalty program.

13. The system according to claim 8 wherein the discretionary distribution module allows the merchant to determine an amount of each incentive fund to be offered to an individual customer based at least one of a historical transaction of the individual customer, a credit rating of the individual customer, a credit score of the individual customer, and estimated or projected crop prices associated with the crop inputs to be purchased, and market prices of crop futures or option contracts for a corresponding projected crop maturity date.

14. The system according to claim 8 wherein the discretionary distribution module provides an electronic tool to the merchant for distribution of the funds among individual customers based on at least one of a historical transaction of an individual customer, a credit rating of the individual customer, a credit score of the individual customer, estimated or projected crop prices associated with the crop inputs to be purchased, a customer loyalty management program, and market prices of crop futures or option contracts for the projected crop maturity date.
